(19) United States
(12) Patent Application Publication
(10) Pub. No.: US 2014/0215145 A1
(43) Pub. Date: Jul. 31, 2014

(54) TAPE DRIVE CACHE MEMORY

(71) Applicant: HEWLETT-PACKARD DEVELOPMENT COMPANY, L.P., (US)

(72) Inventor: Curtis C. Ballard, Fort Collins, CO (US)

(73) Assignee: HEWLETT-PACKARD DEVELOPMENT COMPANY, L.P., Houston, TX (US)

(21) Appl. No.: 13/756,144

(22) Filed: Jan. 31, 2013

(51) Int. Cl. G06F 3/06; G06F 12/08

(52) U.S. Cl. CPC G06F 3/0682; G06F 12/08
USPC 711/111

(57) ABSTRACT

A system including a tape drive having cache memory to detect a smaller partition and a larger partition in a tape and load stored information in the smaller partition into the cache memory to access the cache memory instead of the smaller partition on the tape.

### BACKGROUND

Magnetic tape data storage uses digital recordings on magnetic tape to store digital information. Often, magnetic tape is used for offline, archival data storage, where magnetic tape is the primary copy of stored data. Generally, magnetic tape is cost effective and has long archival stability, such as thirty years or more.

Typically, magnetic tape is packaged in tape cartridges or tape cassettes. Tape drives write data to and read data from these tapes. Autoloaders and tape libraries store the tapes and automate tape handling.

### BRIEF DESCRIPTION OF THE DRAWINGS

FIG. 1 is a diagram illustrating one example of a system that includes a tape drive that detects multiple partitions and loads the smaller partition into a cache memory in accordance with an example of the techniques of the present application.

FIG. 2 is a diagram illustrating one example of a partitioned tape in accordance with an example of the techniques of the present application.

FIG. 3 is a diagram illustrating one example of a system that includes a metadata aware tape drive and tapes in accordance with an example of the techniques of the present application.

FIG. 4 is a diagram illustrating one example of the operation of a metadata aware tape drive in accordance with an example of the techniques of the present application.

FIG. 5 is a diagram illustrating one example of an application interface to a metadata aware tape drive in accordance with an example of the techniques of the present application.

### DETAILED DESCRIPTION

In the following detailed description, reference is made to the accompanying drawings which form a part hereof, and in which is shown by way of illustration specific embodiments in which the techniques of the present application may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the techniques of the present application. It is to be understood that features of the various embodiments described herein may be combined with each other, unless specifically noted otherwise.

Tape drives are sequential access devices that reposition a tape to access different areas of the tape. Some applications create a metadata partition in one region of the tape and one or more data partitions in other regions of the tape. Typically, the metadata partition is smaller in size than the size of each of the one or more data partitions. In one example, the metadata partition can include index information which provides information about the location of data on the tape, as one type of metadata.

Some applications create a separate index partition, which is one type of metadata partition, in one region of the tape and one or more data partitions in other regions of the tape. Typically, the index partition is smaller in size than the size of each of the one or more data partitions. These applications can access the index partition to perform a process to look-up and store information on where data is located in the data partitions. One application that partitions a tape into an index partition and a data partition is a Linear Tape File System (LTFS) application.

In one example, tape drives can position the tape to a location in the metadata partition to access index information and the tape drives reposition the tape to a location in a data partition to access data. Positioning the tape back and forth between locations in the metadata partition and locations in the one or more data partitions can be a lengthy process.

Furthermore, some applications cache metadata from the metadata partition on a server or host computer that the application is operating or executing on. In one example, caching metadata from the metadata partition on a server or host may allow for a process to look-up and update the cache memory on the host computer. However, the index information on the tape can become out of date, and following an event such as a power failure or system crash, the tape may be left with an outdated metadata partition. Also, the process of rebuilding the metadata partition on the tape can be a lengthy process which can include a tape scan process that can take several hours to complete, for example.

In one example, a tape drive, as described herein, can detect a smaller partition and one or more larger partitions on a tape and load the stored information in the smaller partition into a cache memory of the tape drive. In one example, the tape drive can copy the stored information from the smaller partition into the cache memory. The stored information can include index or metadata information about the tape. The metadata partition can include index information to provide location or position of data on the tape. The tape drive can access the cache memory instead of the smaller partition on the tape during operations requesting access to that partition. In one example, the smaller partition can include a metadata partition and the larger partition can include a data partition. In another example, the tape drive can update the smaller partition on the tape in the background at idle points, scheduled intervals, and/or during unloading of the magnetic tape, and the like. The tape drive can read and update the cache memory without moving the tape to the metadata partition on the tape, which can provide rapid access to data in the data partition, especially where the data is located close to the previous position of the tape. In one example, the system can maintain or keep a cache of metadata, including index information, from the metadata partition in the tape drive and perform a read operation and an update operation to the cache memory instead of to the metadata partition on the tape which may improve system performance.

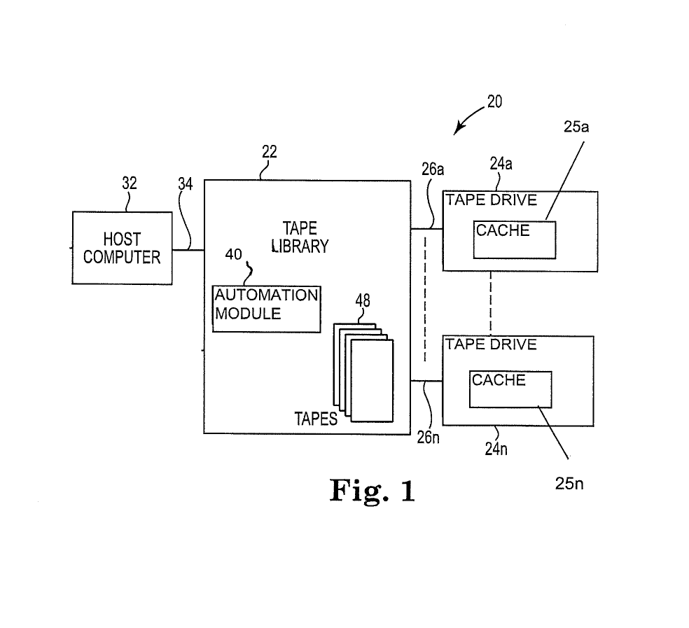

FIG. 1 is a diagram illustrating one example of a system 20 that includes a tape library 22 and tape drives 24a-24n. At least one of the tape drives 24a-24n is configured to detect a smaller partition and one or more larger partitions on a tape and load the stored information in the smaller partition into a cache memory 25a-25n of respective tape drives 24a-24n. The tape drive 24a-24n can access the cache memory instead of the smaller partition on the tape, which can improve system performance. In one example, the tape drive 24a-24n can update the metadata partition on the tape in the background at idle points, scheduled intervals, and/or during unloading of the magnetic tape and the like.

In one example, system 20 includes tape library 22 communicatively coupled to the tape drives 24a-24n via communication channels 26a-26n, respectively. The tape library 22 is communicatively coupled to a host computer 32 via communications channel 34. The host computer 32 can include functionality to communicate with tape library 22 including functionality to exchange with tape library information in the form of commands, data and the like. The host computer 32 can include any device capable of processing data such as a server computer, client computer and the like. The communication channels 26a-26n, 34 can include any communication means such as communication protocols such as Small Computer System Interface (SCSI), Fibre Channel and the like.

In one example, tape library 22 includes tapes 48 and an automation module 40 for inserting each of the tapes 48 into one or more of the tape drives 24a-24n. The automation module 40 includes functionality to control the operation of tape library 22. In one example, automation module 40 can include functionality to exchange information with an external device, such as host computer 32, including commands to access data from tape. In another example, automation module 40 can include functionality in the form of a robotic mechanism to select a tape from a plurality of tapes and insert the tape in a tape drive of the tape library to read data from the tape and write data to the tape. The automation module 40 can be implemented in hardware, software or a combination thereof. Each of the tape drives 24a-24n reads and writes each of the inserted tapes 48 via read and write heads in the tape drive, scan the magnetic media in the tape and transmit data to and from host computer 32 and/or tape library 22.

In one example, tape library 22 can include a record module configured to perform a record process that includes writing data to the tapes. The record module can be implemented in hardware, software, or a combination thereof. In one example, the record module can receive from a host or other electronic device requests to write data to a tape. The record module can cause the tape to move past read/write heads to write data to the tape. The record module can translate the data from an electronic form into a magnetic form that can be written to a tape, such as one of the tapes.

In another example, tape library 22 can include a playback module configured to perform a read or playback process that includes reading data from tapes. The playback module can be implemented in hardware, software, or a combination thereof. In one example, the playback module can receive from a host or other electronic device requests to read data from a tape. The playback module can cause the tape to move past a read/write head to read data from the tape. The playback module can translate data in a magnetic form from the tape into an electronic form and convert the signals to digital form to be processed by the host or other electronic device.

The tapes 48 include magnetic tapes of magnetic medium configured to have two or more partitions, where one of the partitions is a smaller, metadata partition and the other partition or partitions are larger, data partitions. In one example, tapes 48 can include cartridges to support or house magnetic tape formed of magnetic medium to store data in a magnetic form.

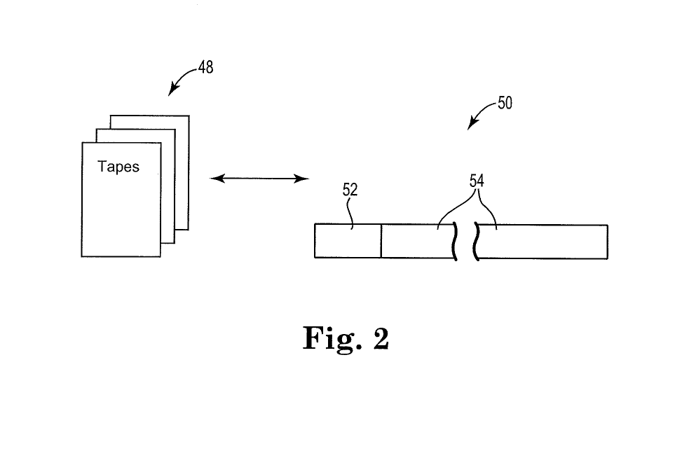

FIG. 2 is a diagram illustrating one example of a partitioned tape 50 from tapes 48. In one example, partitioned tape 50 includes a smaller partition 52 and a larger partition 54. The smaller partition 52 includes a metadata partition and the larger partition 54 is a data partition. The metadata partition can include index information to provide location information of data on the tape. In one example, the smaller partition 52 has a size of 32 gigabytes or larger. In one example, the larger partition 54 has a size of one or more terabytes. In one example, partitioned tape 50 is a linear tape open (LTO) tape cartridge.

In one example, tape 50 can be configured or formatted by applications such as linear tape file system (LTFS). The LTFS application can generate or format two partitions on a tape, such as tape 50. The LTFS application can partition the tape into a smaller index partition and a larger data partition. Each of the partitions can be a tape segment or group of tape segments that are accessed independently of the other partition. The LTFS application can operate or execute on a computer or server, such as host computer 32 (shown in FIG. 1). The LTFS application can provide to the computer or server and/or to other applications a directory file system that is similar to the directory file system of a disk drive. In other examples, different applications can provide proprietary back-up and/or archiving schemes that store information in two or more partitions, including a smaller metadata partition and at least one larger data partition.

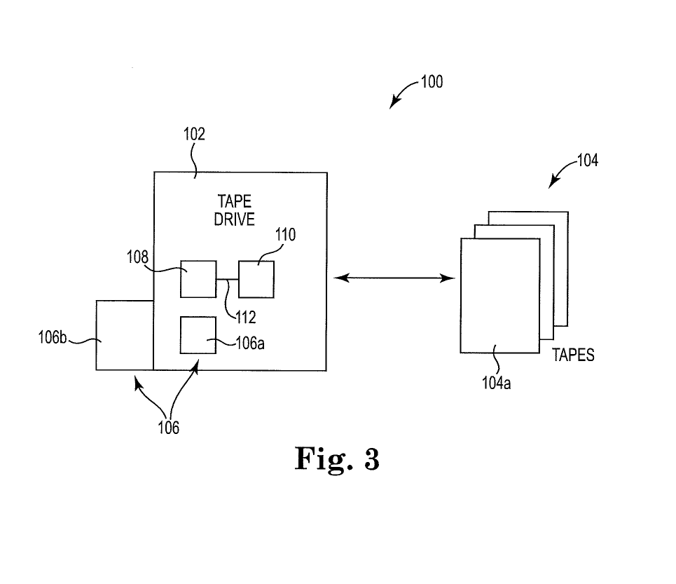

FIG. 3 is a diagram illustrating one example of a system 100 that includes a metadata aware tape drive 102 and tapes 104. In one example, tape drive 102 can detect multiple partitions on each of the tapes 104, including a smaller partition and one or more larger partitions. Tape drive 102 loads the stored information from the smaller partition, which is assumed to be a metadata or index partition, to cache memory 106. The tape drive 102 can access cache memory 106 instead of the smaller partition on one of the tapes 104 to read and update index information. In one example, tape drive 102 is similar to one of the tape drives 24a-24n in system 20. In one example, tapes 104 are similar to tapes 48 (shown in FIG. 1). In one example, one or more of the tapes 104 is formatted by an LTFS application.

In one example, tape drive 102 includes cache memory 106, a processor 108, and system memory 110. The processor 108 can execute software instructions out of system memory 110 via communications channel 112. In one example, tape drive 102 is an LTO tape drive and each of the tapes 104 is an LTO tape cartridge. In another example, tape drive can implement the techniques of the present application using hardware, software or a combination thereof.

In one example, tape drive 102 includes hardware support for removable expansion modules. The cache memory 106 can include on-board cache memory 106a and expansion module cache memory 106b. On-board cache memory 106a is built into tape drive 102 and expansion module cache memory 106b is directly connected or attached to tape drive 102. In other examples, tape drive 102 includes only one of the on-board cache memory 106a and the expansion module cache memory 106b.

In one example, cache memory 106 can include semi-non-volatile or non-volatile memory having a size or storage capacity that is large enough to hold the smaller partition, such as a metadata partition, from each of the tapes 104. In one example, cache memory 106 can include one or more of battery backed memory, super capacitor backed memory, flash memory, electrically erasable programmable read only memory (EEPROM), a disk drive, and the like.

In operation, in one example, tape 104a of the tapes 104 is loaded into tape drive 102 by automation module 40 (shown in FIG. 1). Tape 104a includes a smaller partition, such as smaller partition 52 (shown in FIG. 2), and a larger partition, such as larger partition 54 (shown in FIG. 2). Tape drive 102 detects the smaller partition and the larger partition on tape 104a and loads the stored information in the smaller partition into cache memory 106. In one example, tape drive 102 automatically loads the stored information in the smaller partition into cache memory 106 after tape 104a is physically loaded into tape drive 102. In one example, tape drive 102 indicates that it has the capability of detecting and loading the stored information in the smaller partition into cache memory 106 and accessing cache memory 106 in response to commands for accessing the smaller partition on tape 104a. In one example, tape drive 102 receives commands from an application operating or executing on a host computer, such as host computer 32 (shown in FIG. 1), and the application directs tape drive 102 to detect the multiple partitions and load the stored information in the smaller partition into cache memory 106. In one example, an application operating or executing on a host computer, such as host computer 32 (shown in FIG. 1), reads the index partition of tape 104a and tape drive 102 loads the stored information in the smaller index partition into cache memory 106 at this time.

The tape drive 102 can provide status information such as indicate a good or ready status to an external device, such as tape library 22 or host computer 32 (shown in FIG. 1). In one example, tape drive 102 indicates the good or ready status after loading the stored information in the smaller partition into cache memory 106. In one example, tape drive 102 indicates the good or ready status before loading the stored information in the smaller partition into cache memory 106 and then tape drive 102 loads the stored information in the smaller partition into cache memory 106 in the background.

The tape drive 102 can access cache memory 106 instead of the smaller partition on tape 104a after the cache memory 106 has been loaded and an operation requesting access to the smaller partition has been received. Tape drive 102 receives commands requesting that the tape drive 102 physically locate to the smaller partition of tape 104a. Tape drive 102 responds to these commands with a good or ready status and tape drive 102 indicates its logical position is the smaller partition without physically moving tape 104a. Tape drive 102 accesses cache memory 106 to perform reads and updates of the smaller partition information in cache memory 106, instead of accessing the smaller partition on tape 104a. Accessing cache memory 106 instead of the smaller partition on tape 104a can improve the performance of system 100. In one example, tape drive 102 can perform substantially as well as a disk drive when accessing the smaller partition.

The tape drive 102 can update the smaller partition on tape 104a with the information in cache memory 106 to synchronize cache memory 106 and the smaller partition on tape 104a. In one example, tape drive 102 updates the smaller partition on tape 104a with the information in cache memory 106 in the background at an idle point, for example. In one example, tape drive 102 updates the smaller partition on tape 104a with the information in cache memory 106 just before tape 104a is unloaded form tape drive 102. In one example, tape drive 102 updates the smaller partition on tape 104a with the information in cache memory 106 based on a schedule or other process.

In one example, tape drive 102 stores the stored information in the smaller partition of one of the tapes 104 in cache memory 106 and tape drive 102 stores at least part of a larger partition of the one of the tapes 104 in cache memory 106 and/or system memory 110. Tape drive 102 accesses the information in cache memory 106, such as index information, and sometimes tape drive 102 accesses the part of the larger partition in cache memory 106 and/or memory 110, which is part of a data partition. Accessing both the metadata partition and the data partition in cache memory 106 and/or system memory 110 can improve the performance of system 100.

In one example, in the case of an event, such as a power failure or system crash, tape drive 102 can read cache memory 106 after being powered back up or restored and tape drive 102 can update the smaller partition on tape 104a. This may avoid having to rebuild the metadata partition on tape 104a, which can otherwise be a lengthy process that can include a tape scan process which can take a long period to complete such as several hours.

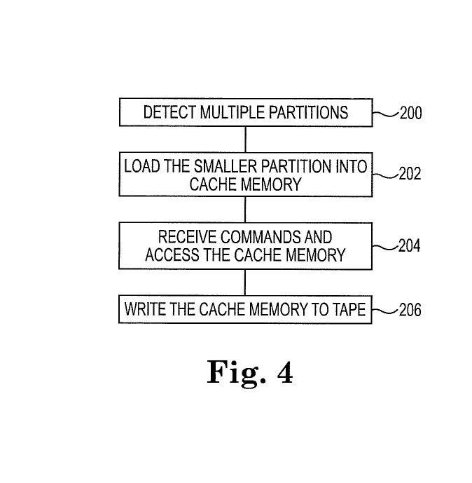

FIG. 4 is a diagram illustrating one example of the operation of a metadata aware tape drive, such as tape drive 102. To illustrate operation, it can be assumed that a tape is loaded into the tape drive by automation module 40 (shown in FIG. 1), where the loaded tape includes a smaller partition, such as smaller partition 52 (shown in FIG. 2), and a larger partition, such as larger partition 54 (shown in FIG. 2). At block 200, the tape drive detects the multiple partitions in the tape, including the smaller partition and at least one larger partition. In one example, the smaller partition is an index partition and the larger partition is a data partition.

At block 202, the tape drive loads the stored information in the smaller partition on the tape into a cache memory of the tape drive, such as cache memory 106. In one example, the tape drive automatically loads the stored information in the smaller partition into cache memory after the tape is physically loaded into the tape drive. In one example, an application operating or executing on a host computer, such as host computer 32 (shown in FIG. 1), reads the index partition of the tape and the tape drive loads the stored information in the smaller index partition into cache memory at this time.

In one example, the tape drive can provide information or indicate that it has the capability of detecting multiple partitions on the tape, load the stored information in the smaller partition on the tape into cache memory of the tape drive, and access the cache memory in response to commands for accessing the smaller partition on the tape. An application operating or executing on a host computer, such as host computer 32 (shown in FIG. 1), receives this indication and responds to the indication in a command. The tape drive receives commands from the application directing the tape drive to either forgo the multiple partition functionality or to detect the multiple partitions, load the stored information in the smaller partition into cache memory of the tape drive, and access the cache memory in response to commands for accessing the smaller partition on the tape.

At block 204, the tape drive receives commands from an application, such as an application running on host computer 28 and/or host computer 32, requesting the smaller partition on the tape. The tape drive responds to these commands with status information such as a good or ready status and indicates its logical position is the smaller partition, without physically moving the tape. The tape drive accesses the cache memory in response to these commands and performs reads and updates of the information in cache memory, instead of accessing the smaller partition on the tape.

At block 206, the tape drive writes the cache memory to the smaller partition on the tape to synchronize the cache memory with the smaller partition on the tape. In one example, the tape drive writes the cache memory to the smaller partition on the tape in the background, during idle time. In one example, the tape drive updates the smaller partition on the tape with the information in cache memory just before the tape is unloaded form the tape drive. In one example, the tape drive updates the smaller partition on the tape with the information in cache memory based on a schedule.

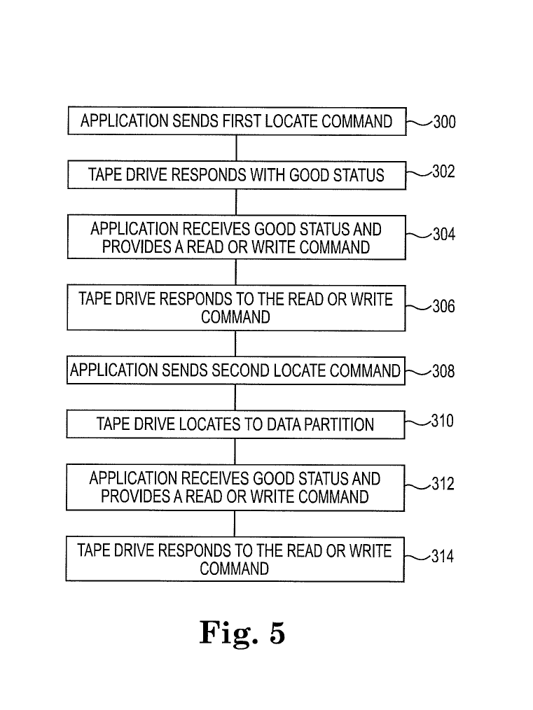

FIG. 5 is a diagram illustrating one example of an application interface to a metadata aware tape drive, such as tape drive 102. In one example, the application interface to the metadata aware tape drive is the same as the interface to a non-metadata aware tape drive.

At block 300, the application sends a first locate command to the tape drive, which directs the tape drive to locate to a position in the metadata partition. At block 302, the tape drive responds to this command with a good or ready status and indicates its logical position is at the location in the metadata partition, without physically moving the tape.

At block 304, the application receives the good or ready status from the tape drive and provides a read command or a write command to the tape drive. At block 306, the tape drive responds to the read command or to the write command. In response to a read command, the tape drive reads index information from the cache memory. In response to a write command, the tape drive updates index information in the cache memory.

At block 308, the application sends a second locate command to the tape drive, which directs the tape drive to locate to a position in the data partition. In one example, the tape drive locates to a position in the data partition indicated by index information read from cache memory at block 306.

At block 310, the tape drive moves the tape to the position in the data partition indicated by the second locate command and responds with a good or ready status. In another example, at least part of the data partition is cached in cache memory and/or system memory of the tape drive and the tape drive accesses the data from the cache memory and/or system memory of the tape drive, without moving the tape.

At block 312, the application receives the good or ready status from the tape drive and provides another read command or write command to the tape drive. At block 314, the tape drive responds to the read command or to the write command. In response to a read command, the tape drive reads data, and in response to a write command, the tape drive updates the data in the data partition. This process can continue via other commands and responses from the application and the tape drive.

The metadata aware tape drive includes index information in cache memory to provide faster access to index information and data, which may improve system performance. For example, having the tape drive cache the metadata or index information may allow for faster access of the information in the tape drive so that application or drive, such as an LTFS application or driver, is aware of the drive cache capability and may use the cache in the drive instead of the local cache.

The techniques of the present application can be implemented on a tape drive having machine-readable instructions executable on one or multiple processors. The processor(s) is (are) connected to machine-readable storage media and to a network interface that allows the tape drive to communicate over a network. A processor can include a microprocessor, microcontroller, processor module or subsystem, programmable integrated circuit, programmable gate array, or another control or computing device. The machine-readable (or computer-readable) storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

Although specific embodiments have been illustrated and described herein, it will be appreciated that a variety of alternate and/or equivalent implementations may be substituted for the specific embodiments shown and described without departing from the scope of the techniques of the present application. This application is intended to cover any adaptations or variations of the specific embodiments discussed herein.

1. A system comprising:
a cache memory; and
a tape drive coupled to the cache memory, wherein the tape drive to detect a smaller partition and a larger partition in a tape and load stored information in the smaller partition into the cache memory to access the cache memory instead of the smaller partition on the tape.

2. The system of claim 1, wherein the tape drive is configured to read and update the cache memory in response to commands for accessing the smaller partition on the tape.

3. The system of claim 1, wherein the tape drive is configured to write the cache memory to the smaller partition on the tape to synchronize the cache memory with the smaller partition on the tape.

4. The system of claim 1, wherein the smaller partition is a metadata partition and the larger partition is a data partition.

5. The system of claim 1, wherein the cache memory includes a removable memory module.

6. The system of claim 1, wherein the cache memory includes memory built into the tape drive.

7. The system of claim 1, wherein the cache memory includes at least one of battery backed memory, super capacitor backed memory, flash memory, EEPROM, and disk drive memory.

8. The system of claim 1, wherein the tape drive to indicate that the tape drive has the capability of detecting and loading the stored information in the smaller partition into the cache memory and accessing the cache memory in response to commands for accessing the smaller partition on the tape.

9. A system comprising:
a cache memory; and
a tape drive coupled to the cache memory, the tape drive to detect a smaller partition and a larger partition in a tape and load stored information in the smaller partition into the cache memory and access the cache memory in response to commands to access the smaller partition on the tape, wherein the tape drive to indicate that the tape drive is capable of detecting and loading the stored information in the smaller partition into the cache memory and accessing the cache memory in response to commands for accessing the smaller partition on the tape.

10. The system of claim 9, wherein the tape drive is directed by an application to detect the smaller partition and the larger partition in the tape and to load the stored information in the smaller partition into the cache memory and access the cache memory in response to commands for accessing the smaller partition on the tape.

11. The system of claim 9, wherein the tape drive is configured to automatically detect and load the stored information in the smaller partition into the cache memory and access the cache memory in response to commands to access the smaller partition on the tape.

12. The system of claim 9, wherein the tape drive is configured to receive commands to locate to the smaller partition and the tape drive changes the logical address to the cache memory in response to the commands.

13. The system of claim 9, wherein the cache memory includes a removable memory module attached to the tape drive.

14. The system of claim 9, wherein the cache memory includes memory built into the tape drive.

15. A method comprising:
detecting a smaller partition and a larger partition on a tape by a tape drive;
copying stored information in the smaller partition from the tape into a cache memory of the tape drive; and
accessing the cache memory in response to commands for accessing the smaller partition on the tape.

16. The method of claim 15, comprising:
reading and updating the cache memory in response to commands for accessing the smaller partition on the tape.

17. The method of claim 15, comprising:
writing the cache memory to the smaller partition on the tape to synchronize the cache memory with the smaller partition on the tape.

18. The method of claim 17, wherein writing the cache memory to the smaller partition comprises:
writing the cache memory to the smaller partition on the tape to synchronize the cache memory with the smaller partition on the tape in the background, based on one or more of idle time, unloading of the tape, and a schedule.

19. The method of claim 15, comprising:
indicating that the tape drive can detect the smaller partition and the larger partition on the tape, load the stored information in the smaller partition from the tape into the cache memory of the tape drive, and access the cache memory in response to commands for accessing the smaller partition on the tape to an application on a server.

20. The method of claim 19, comprising:
receiving directions from the application to detect the smaller partition and the larger partition on the tape, load the stored information in the smaller partition from the tape into the cache memory of the tape drive, and access the cache memory in response to commands for accessing the smaller partition on the tape.
